(19) United States
(12) Patent Application Publication
(10) Pub. No.: US 2008/0282029 A1
(43) Pub. Date: Nov. 13, 2008

(54) STRUCTURE FOR DYNAMIC OPTIMIZATION OF DYNAMIC RANDOM ACCESS MEMORY (DRAM) CONTROLLER PAGE POLICY

(76) Inventors: Ganesh Balakrishnan, Apex, NC (US); Anil Krishna, Cary, NC (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/109,774

(22) Filed: Apr. 25, 2008

Related U.S. Application Data
(63) Continuation-in-part of application No. 11/746,411, filed on May 9, 2007.

(51) Int. Cl. G06F 12/00

(52) U.S. Cl. 711/105; 711/E12.001

(57) ABSTRACT

A design structure embodied in a machine readable storage medium for designing, manufacturing, and/or testing a design for dynamic optimization of DRAM controller page policy is provided. The design structure can include a memory module, which can include multiple different memories, each including a memory controller coupled to a memory array of memory pages. Each of the memory pages in turn can include a corresponding locality tendency state. A memory bank can be coupled to a sense amplifier and configured to latch selected ones of the memory pages responsive to the memory controller. Finally, the module can include open page policy management logic coupled to the memory controller. The logic can include program code enabled to granularly change open page policy management of the memory bank responsive to identifying a locality tendency state for a page loaded in the memory bank.

### CROSS-REFERENCE TO RELATED APPLICATION

This application is a continuation-in-part of co-pending U.S. patent application Ser. No. 11/746,411, filed May 9, 2007, which is herein incorporated by reference.

### BACKGROUND OF THE INVENTION

1. Field of the Invention

The present invention is generally related design structures, and more specifically, design structures in the field of dynamic random access memory (DRAM) control and more particularly to DRAM paging.

2. Description of the Related Art

The memory controller provides the control logic to orchestrate the movement of data to and from dynamic random access memory (DRAM). In operation, a read command can be issued to a DRAM in order to move a fixed amount of data from the DRAM to a requesting device such as a processor cache in a central processing unit (CPU). In response, a sequence of control signals can move the requested data from the DRAM device to the memory controller and eventually to the requesting hardware. In the course of retrieving the requested data, a chip select signal can select an appropriate DRAM from amongst a set of DRAMs, the selected DRAM being referred to as a “rank”.

Thereafter, a bank address signal can select the correct array in the selected DRAM, known as a “bank”, as required to satisfy the data request. Finally, an activate signal also referred to as a row access strobe or RAS signal can select a row in the appropriate bank. Notably, the activate signal connects the correct row of bits in the bank to sense amplifiers. The sense amplifiers, in turn, can latch an entire row of bits from the analog domain in the bank into the digital domain. This resulting row of bits is referred to as a “page” of physical memory.

After a threshold number of DRAM cycles the memory controller can send “read”, “write”, “read with auto pre-charge” or “write with auto pre-charge” signals to the DRAM. These signals either read from a certain portion of the sense amplifiers or write to a certain portion of the sense amplifiers, usually filling a cache line worth of bytes. The auto pre-charge signal, if specified with the read or write command can cause the sense amplifiers to lose latched data after the read or the write operation completes. This has been referred to in the art as “closing” the page or “pre-charging” the bank. In the event that the auto pre-charge signal has not been implicitly requested at the time of the read or the write command, then the pre-charge signal must be explicitly sent by the memory controller to the DRAM devices. Otherwise, the page will remain “open” until the next refresh cycle which will cause the bank to become pre-charged.

Refreshes are known to be relatively infrequent compared to the request rate, and therefore leaving the page open can be beneficial if there is reason to believe that the next access to the same bank will also be to the same page. Leaving the page open necessarily requires maintaining the charge on the sense amplifiers until explicitly removed by a pre-charge signal at a later time. A pre-charge signal eventually will be required if a different row in the DRAM array is to be read. In this circumstance, the content of the different row must be moved to the sense amplifiers, prior to which a pre-charge operation will be required.

Micro-architecture designers at design time select one of two modes of computing for a memory controller in a microprocessor system depending upon the nature of the applications expected for operation in the system. Specifically, the modes include an open page mode and a closed page mode. In the open page mode, the memory controller leaves data brought into the sense amplifiers as is after an initial read or write operation. This allows a faster access to the same “page” of data, the next time a read or a write request to the same page is received in the memory controller. Referred to as a “page hit”, such reuse of data in a page is usually expected when there is only one thread of execution running in the CPU at a given time and the data accesses made by that thread are relatively sequential in nature.

In the closed page mode, by comparison, the memory controller can close the page after handling a read or write command. Consequently, there can never be a “page miss” arising where a page in a bank is open, when a different page in the same bank is required to be opened. A page miss causes a longer delay than a permissible “page idle” condition where no page was open at the outset. In the page miss condition, the open page first must be closed, e.g. pre-charged. Only then can the correct page be opened or activated and a read or write can initiate. While a “page miss” can occur in a memory controller operating in an open page mode, in the closed page mode only “page idles” can occur. As such, memory latency can be better predicted. Accordingly, a closed page mode can be effective in supporting applications having a highly random access pattern with multiple threads of execution sharing a memory controller.

Notwithstanding, processors exist that intend to support both applications with highly randomized access and applications with sequential access to data in memory. The anticipated applications can run under both types of thread scenarios, sometimes running only one thread of execution and sometimes running multiple threads from multiple users. In the past, memory controller designs allowed moving the memory controller from open page mode to closed page mode depending upon an observed memory access pattern. When detecting changes in access patterns, the memory controller can switch to a closed page mode to reduce page misses or to an open page mode to capitalize upon page hits.

There are, however, applications that experience both access patterns during different program phases. In search applications, for instance, the same thread of execution jumps seemingly randomly across a large database based upon a search key, and upon locating the key, the execution changes in character to a sequential access pattern for a significant number of accesses. After some time, the execution of the application again changes to random access and so on. With many threads of such an application running, a properly configured memory controller must identify or designate the overall system access as sequential or random, even at a given instant in time.

### BRIEF SUMMARY OF THE INVENTION

Embodiments of the present invention address deficiencies of the art in respect to memory management and provide a novel and non-obvious method, system and computer program product for dynamic optimization of DRAM controller page policy. In one embodiment of the invention, a memory module can include multiple different memories, each including a memory controller coupled to a memory array of memory pages. Each of the memory pages in turn can include a corresponding locality tendency state. A memory bank can be coupled to a sense amplifier and configured to latch selected ones of the memory pages responsive to the memory controller. Finally, the module can include open page policy management logic coupled to the memory controller.

The logic can include program code enabled to granularly change open page policy management of the memory bank responsive to identifying a locality tendency state for a page loaded in the memory bank. In this regard, the program code can perform a memory management method including identifying a locality tendency state for an existing memory page in a memory bank for a memory array, receiving a memory request for the memory bank, transitioning the locality tendency state responsive to determining either a page hit or a page miss for the memory request, storing the transitioned locality tendency state in association with the existing memory page in the memory array, and closing the memory page in response to a page miss, but leaving open the memory page in response to a page hit.

The method additionally can include further receiving a memory request for a memory page in the memory array, loading the memory page and an associated locality tendency state for the memory page in the memory bank and accessing the memory page in the memory bank. In response to determining the associated locality tendency state to be a closed state, the memory page can be closed subsequent to accessing the memory page, but otherwise the memory page can be left open in the memory bank and the locality tendency state can be transitioned to a weakly opened state if another request for the memory page is pending, or if the memory page had immediately previously been opened and then closed in the memory bank. By comparison, in response to determining the locality tendency state to be a weakly opened state, the locality tendency state can be transitioned to an open state and leaving the existing memory page open in the memory bank. Finally, in response to determining the locality tendency state to be an open state, the locality tendency state can be transitioned to a strongly opened state and leaving the existing memory page open in the memory bank.

In another embodiment, a design structure embodied in a machine readable storage medium for at least one of designing, manufacturing, and testing a design is provided. The design structure generally includes a memory module. The memory module generally includes a plurality of memories. Each memory generally includes a memory controller coupled to a memory array of memory pages, and each of the memory pages generally includes a corresponding locality tendency state. The memory module further includes a memory bank coupled to a sense amplifier and configured to latch selected ones of the memory pages responsive to the memory controller, and open page policy management logic coupled to the memory controller, the logic comprising program code enabled to granularly change open page policy management of the memory bank responsive to identifying a locality tendency state for a page loaded in the memory bank.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a memory management data processing system configured for dynamic optimization of DRAM controller page policy; and,

FIG. 2 is a state diagram illustrating a process for dynamic optimization of DRAM controller page policy.

FIG. 3 is a flow diagram of a design process used in semiconductor design, manufacture, and/or test.

### DETAILED DESCRIPTION OF THE INVENTION

Embodiments of the present invention provide a method, system and computer program product for dynamic optimization of DRAM controller page policy. In accordance with an embodiment of the present invention, a state can be assigned to each page opened in a bank managed by a memory controller in a memory module. The state can change for each page depending upon whether a page hit or page miss condition arises in the managing memory controller. Thereafter, the state can transition and the page can be closed or remain open as dictated by the state and rules for leaving open or closing pages having particular ones of the states. In this way, the controller page policy can be granularly tuned according to dynamic conditions sensed for the pages of the bank.

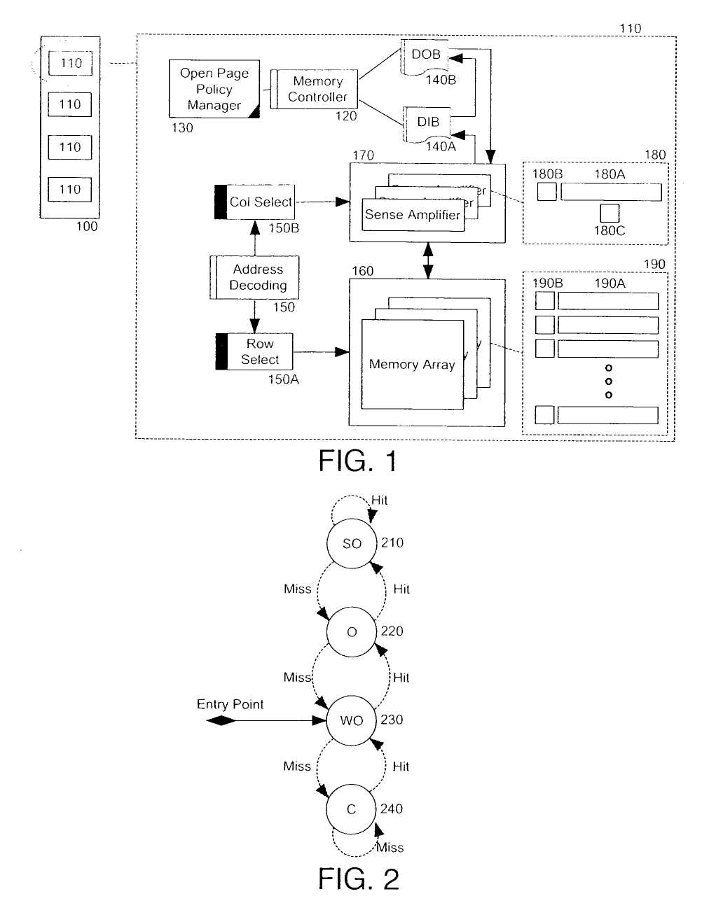

In further illustration, FIG. 1 is a schematic illustration of a memory management data processing system configured for dynamic optimization of DRAM controller page policy. The memory management data processing system can include a memory module 100 including one or more memories 110, such as DRAMs. Each of the memories 110 can include a set of memory arrays 160 and corresponding sense amplifiers 170. Address decoding logic 150 further can be provided to receive a row select instruction 150A and a column select instruction 150B to retrieve a page of data from a specified one of the memory arrays 160 into a corresponding one of sense amplifiers 170.

A memory controller 120 can be configured to manage the movement of data to and from the memory 110 of the memory module 100. In this regard, data latched in the sense amplifiers 170 further can be shepherded into a data-in buffer 140A by the memory controller 120 for processing a read operation from the memory module 100, or into a data-out buffer 140B by the memory controller 120 for processing a write operation in the memory module 100. Importantly, whether or not a pre-charge signal is provided subsequent to latching a page in the sense amplifiers 170 and the choice of address hashing scheme utilized during read and write operations can depend on the page policy applied by the memory controller 120.

In this regard, open page policy manager 130 can be coupled to the memory controller 120 and can alternately provide for degrees of an open page mode in performing read operations, and write operations in the memory 110 depending upon a tendency of locality detected for a given page of memory. The tendency can be recorded in a locality tendency state 180B applied to a page 180A in a bank 180 latched by a corresponding one of the sense amplifiers 170. Specifically, the locality tendency state 180B can range from an open state, a weakly open state, a strongly open state and a closed state, and the locality tendency state 180B can transition from state to state depending upon the occurrence of a page hit or a page miss. In addition, a last page record 180C can be provided for the bank to indicate a last page opened and then closed in the bank 180. Notably, when the a page 180A is written back to a respective one of the memory arrays 160, the locality tendency state 180B also can be written back in association with the page 180A. Consequently, pages 190 in each of the memory arrays 160 can include not only individual pages 190A of memory, but also corresponding locality tendency states 190B.

In operation, when a data request is received in the memory controller 120, both the requested page 190A and its corresponding locality tendency state 190B can be latched into bank 180 as page 180A and locality tendency state 180B by a corresponding one of the sense amplifiers 170. The locality tendency state 180B can be updated depending upon whether a page hit or page miss has occurred. The locality tendency state 180B can range from open, to strongly open, to weakly open, to closed. In the open state, if a page hit is generated on an open page 180A, a strongly open state will result indicating a potential locality of access within the page 180A that could be exploited by leaving the page 180A in an open state. In contrast, in the open state if a page miss is generated, a weakly open state can result and the page 180A can be closed. In the strongly open state, a page hit does not change the locality tendency state 180B, though a page miss reduces the locality tendency state 180B to an open state while the page 180A is closed.

By comparison, in a weakly open state—the default locality tendency state for a page 180A—the page 180A remains open until a page request is received for the bank 180. Thereafter, a page hit results in a transition to the open state while a page miss results in a transition to the closed state and the closing of the page 180A. Finally, in a closed state, a page 180A will be closed immediately after the first access to the page 180A. In the unlikely event of a page miss, the locality tendency state 180B of the page 180A will remain closed, while a page hit will result in a transition to the weakly open state only if additional requests to the request are detected by the open page policy manager 130 in a request queue, or if the page 180A had previously been opened as indicated by the last page record 180C for the bank 180.

In yet further illustration, FIG. 2 is a state diagram illustrating a process for dynamic optimization of DRAM controller page policy. As shown in FIG. 2, an initial state of weakly opened 230 can be assigned to a page latched in a memory bank. A page hit promotes the latched page to a state of open 220, while a page miss demotes the page into a state of closed 240. In the former circumstance, the page can remain open while in the latter circumstance the page can be closed. When in the state of open 220, a page hit results in a transition to the state of strongly opened 210, while a page miss results in a demotion to a state of weakly opened 230. In the former circumstance, the page can remain open, while in the latter circumstance the page can be closed.

In the state of strongly opened 210, a page hit results in no transition and a page miss results in a transition to the state of open 220. In the former circumstance, the page can remain open, while in the latter circumstance the page can be closed. Finally, in the state of closed 240, a page miss results in no state transition. However, a page hit unto itself also results in no state transition. Rather, a state transition to the state of weakly opened 230 only arises where a page hit occurs whilst an additional page request for the page exists in a request cache for the memory controller. Alternatively, a state transition to the state of weakly opened 230 can arise where a page hit occurs on a page that had immediately previously been opened.

The persistence of an indication of locality tendency for each page provides the ability for the memory controller to granularly control the open page policy for memory paging. Whereas conventional memory controllers are configured statically as open page mode controllers or closed page mode controllers, the consideration of locality tendency and the support of the state machine transitioning to different states of locality tendency permit a finer management of open page mode memory control.

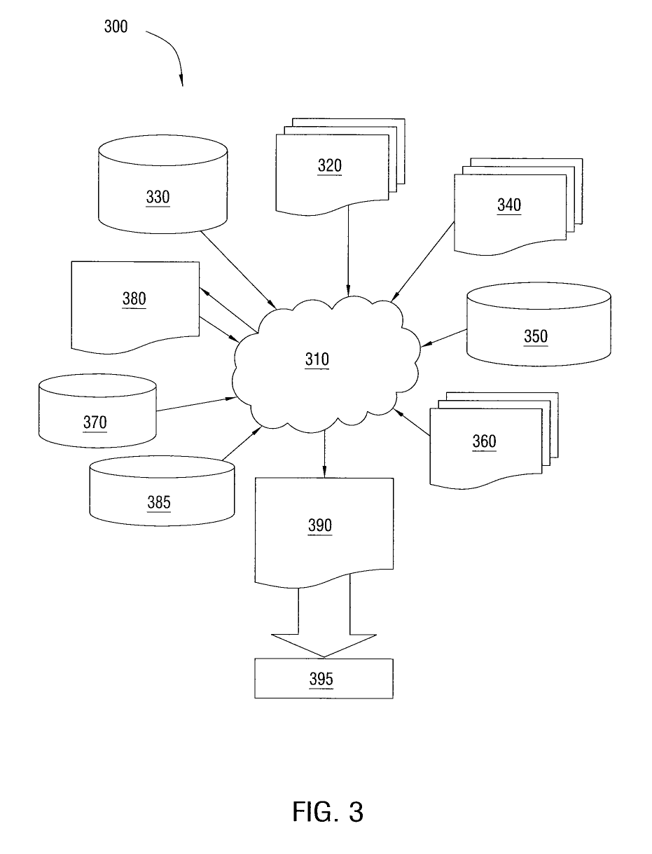

FIG. 3 shows a block diagram of an exemplary design flow 300 used for example, in semiconductor design, manufacturing, and/or test. Design flow 300 may vary depending on the type of IC being designed. For example, a design flow 300 for building an application specific IC (ASIC) may differ from a design flow 300 for designing a standard component. Design structure 320 is preferably an input to a design process 310 and may come from an IP provider, a core developer, or other design company or may be generated by the operator of the design flow, or from other sources. Design structure 320 comprises the circuit described above and shown in FIG. 1 in the form of schematics or HDL, a hardware-description language (e.g., Verilog, VHDL, C, etc.). Design structure 320 may be contained on one or more machine readable medium. For example, design structure 320 may be a text file or a graphical representation of a circuit as described above and shown in FIG. 1. Design process 310 preferably synthesizes (or translates) the circuit described above and shown in FIG. 1 into a netlist 380, where netlist 380 is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. The medium may also be a packet of data to be sent via the Internet, or other networking suitable means. The synthesis may be an iterative process in which netlist 380 is resynthesized one or more times depending on design specifications and parameters for the circuit.

Design process 310 may include using a variety of inputs; for example, inputs from library elements 330 which may house a set of commonly used elements, circuits, and devices, including models, layouts, and symbolic representations, for a given manufacturing technology (e.g., different technology nodes, 32 nm, 45 nm, 90 nm, etc.), design specifications 340, characterization data 350, verification data 360, design rules 370, and test data files 385 (which may include test patterns and other testing information). Design process 310 may further include, for example, standard circuit design processes such as timing analysis, verification, design rule checking, place and route operations, etc. One of ordinary skill in the art of integrated circuit design can appreciate the extent of possible electronic design automation tools and applications used in design process 310 without deviating from the scope and spirit of the invention. The design structure of the invention is not limited to any specific design flow.

Design process 310 preferably translates a circuit as described above and shown in FIG. 1, along with any additional integrated circuit design or data (if applicable), into a second design structure 390. Design structure 390 resides on a storage medium in a data format used for the exchange of layout data of integrated circuits (e.g. information stored in a GDSII (GDS2), GL1, OASIS, or any other suitable format for storing such design structures). Design structure 390 may comprise information such as, for example, test data files, design content files, manufacturing data, layout parameters, wires, levels of metal, vias, shapes, data for routing through the manufacturing line, and any other data required by a semiconductor manufacturer to produce a circuit as described above and shown in FIG. 1. Design structure 390 may then proceed to a stage 395 where, for example, design structure 390: proceeds to tape-out, is released to manufacturing, is released to a mask house, is sent to another design house, is sent back to the customer, etc.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

What is claimed is:

1. A design structure embodied in a machine readable storage medium for at least one of designing, manufacturing, and testing a design, the design structure comprising:
a memory module comprising:
a plurality of memories, each memory comprising a memory controller coupled to a memory array of memory pages, each of the memory pages comprising a corresponding locality tendency state;
a memory bank coupled to a sense amplifier and configured to latch selected ones of the memory pages responsive to the memory controller; and,
open page policy management logic coupled to the memory controller, the logic comprising program code enabled to granularly change open page policy management of the memory bank responsive to identifying a locality tendency state for a page loaded in the memory bank.

2. The design structure of claim 1, wherein the memories are dynamic random access memories (DRAMs).

3. The design structure of claim 1, wherein the tendency state is selected from a group of states comprising an open state, a weakly opened state, a strongly opened state and a closed state.

4. The design structure of claim 3, further comprising a locality tendency state machine managed by the open page policy management logic, wherein the locality tendency state for a memory page in the memory bank is determined by the state machine according to an occurrence of either a page hit or a page miss for the memory bank in satisfying a memory request in the memory controller.

5. The design structure of claim 1, further comprising a last page record for the memory bank indicating a last memory page closed from the memory bank.

6. The design structure of claim 1, wherein the design structure comprises a netlist, which describes the memory module.

7. The design structure of claim 1, wherein the design structure resides on the machine readable storage medium as a data format used for the exchange of layout data of integrated circuits.
